(19) United States
(12) Patent Application Publication
(10) Pub. No.: US 2026/0367677 A1
(43) Pub. Date: Nov. 19, 2026

(54) INFORMATION PROCESSING APPRATUS WITH ADJUSTABLE CHASSIS HEIGHT

(71) Applicant: Lenovo (United States) Inc., Morrisville, NC (US)

(72) Inventors: Débora Soares Santos Gumiero, Morrisville, NC (US); Alanderson Salomão Gonçalves, Morrisville, NC (US)

(73) Assignee: Lenovo (United States) Inc., Morrisville, NC (US)

(21) Appl. No.: 19/210,580

(22) Filed: May 16, 2025

(51) Int. Cl. G06F 1/16

(52) U.S. Cl. CPC G06F 1/1683; G06F 1/1616; G06F 1/1624; G06F 1/1637

(57) ABSTRACT

An information processing apparatus includes a chassis support, a first chassis slidably mounted on the chassis support, and a second chassis rotatably connected to the chassis support by a hinge. The first chassis is electronically connected to the second chassis by wiring that extends from the first chassis to the second chassis through an interior of the chassis support. The information processing apparatus further includes a locking system that locks the first chassis in a first position. In response to releasing the locking system and sliding the first chassis to a second position in a direction away from the hinge, the locking system locks the first chassis in the second position.

### BACKGROUND

Users increasingly rely on information processing apparatuses, such as computers, throughout their daily routines. Using an information processing apparatus for prolonged periods of time imparts a significant physical demand on the user that is exacerbated by their posture. Over time, the physical demand experienced by the user may lead to discomfort and lack of productivity. Users may improve their posture and quality of interaction with the information processing apparatus by using external devices connected to the primary information processing apparatus, such as external displays, stands, and input devices (e.g., keyboards). However, such external devices reduce the portability of the information processing apparatus, increase its energy demand, and add costs.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to information processing apparatus including a chassis support, a first chassis slidably mounted on the chassis support, and a second chassis rotatably connected to the chassis support by a hinge. The first chassis is electronically connected to the second chassis by wiring that extends from the first chassis to the second chassis through an interior of the chassis support. The information processing apparatus further includes a locking system that locks the first chassis in a first position. In response to releasing the locking system and sliding the first chassis to a second position in a direction away from the hinge, the locking system locks the first chassis in the second position.

### BRIEF DESCRIPTION OF DRAWINGS

FIG. 1 depicts an information processing apparatus according to one or more embodiments of the disclosure.

FIG. 2 depicts an information processing apparatus according to one or more embodiments of the disclosure.

FIG. 3 depicts an information processing apparatus according to one or more embodiments of the disclosure.

FIG. 4 depicts an information processing apparatus in accordance with one or more embodiments of the disclosure.

FIGS. 5A and 5B depict a chassis and a chassis support of an information processing apparatus in accordance with one or more embodiments.

### DETAILED DESCRIPTION

Specific embodiments of the present disclosure will now be described in detail below with reference to the accompanying drawings. Like elements in the various figures are denoted by like reference numerals for consistency.

In the following detailed description of embodiments of the disclosure, numerous specific details are set forth to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (e.g., any noun in the application). The use of ordinal numbers is not intended to imply or create a particular ordering of the elements nor to limit any element to being only a single element unless expressly disclosed, such as using the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

Conventional information processing apparatuses include personal computers like desktop computers and laptop/notebook computers, smart phones, personal data assistants (PDAs), and tablet computing devices. Modern business, education, and entertainment increasingly rely on such information processing apparatuses. Consequently, users spend prolonged periods of time interacting with and using information processing apparatuses. These prolonged periods of use can create a physical toll on a user that is made worse by their posture. For example, poor posture during use may lead to discomfort and even injury if not ameliorated. In addition, users may experience dissatisfaction and lack of productivity due to their poor posture while using the information processing apparatus.

Not all information processing apparatuses encourage or easily facilitate a good posture, or a posture that does not lead to discomfort during periods of prolonged use. In such instances, a user may need to place the information processing apparatus on a stand or connect external devices, such as external input devices (e.g., a mouse or a keyboard) and external displays to improve their posture while using the information processing apparatus, However, these additional components significantly reduce the portability of the information processing apparatus(add costs to the user, and may increase energy demand.

Embodiments of the present disclosure provide an information processing apparatus with a chassis support that enables a chassis secured thereto to have an adjustable height. The chassis support reduces the need for external equipment in order for a user to assume a healthy posture while using the information processing apparatus(thereby reducing costs and promoting user productivity, health, and experience.

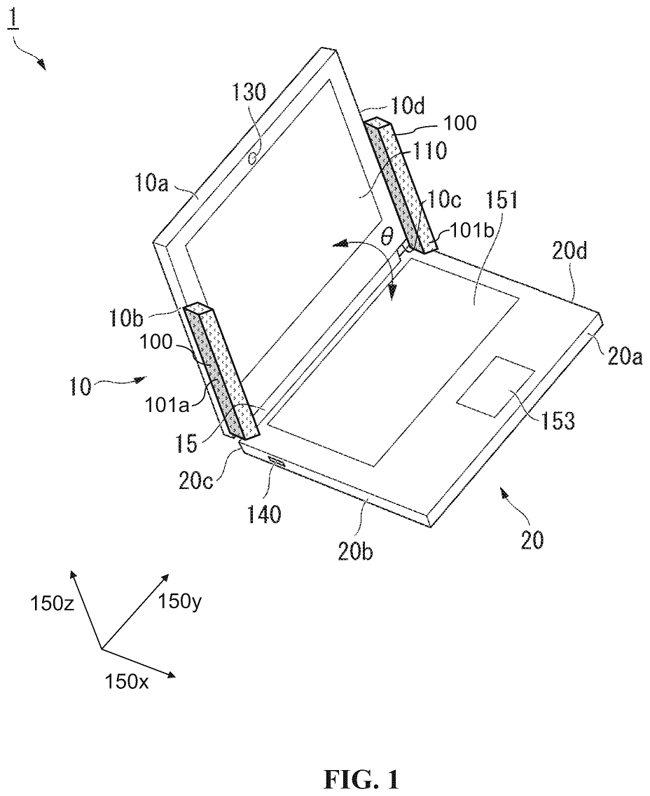

FIG. 1 depicts an information processing apparatus (1) according to one or more embodiments of the disclosure. In particular, FIG. 1 shows a perspective view of the information processing apparatus (1). Herein, the information processing apparatus (1) is a laptop PC (Personal Computer) with a standard clamshell design.

The information processing apparatus (1) includes a first chassis (10) and a second chassis (20). The first chassis (10) is rotatable relative to the second chassis (20) around the rotation axis of a hinge (15). The hinge (15) is fixed to the second chassis (20). An angle between the first chassis (10) and the second chassis (20) is denoted by “θ” in FIG. 1. The first chassis (10) may be referred to as an A cover or a display chassis, while the second chassis (20) may be referred to as a C cover or a system chassis. As depicted, the first chassis (10) and second chassis (20) each have a respective first side face (10a, 20a), second side face (10b, 20b), third side face (10c, 20c), and fourth side face (10d, 20d) defining an outer boundary of the information processing apparatus (1).

The information processing apparatus includes a power button (140) on the side face (20b) of the second chassis (20). The power button (140) is an element operated by the user transmit a command to the information processing apparatus (1) to power on or power off, transition from a standby state to a normal operating state, transition from the normal operating state to the standby state, or to activate another state.

The information processing apparatus (1) also includes a keyboard (151) and a touch pad (153) on the inner face of the second chassis (20) as input devices. The information processing apparatus (1) may also include external connected devices (not shown) such as an external keyboard or an external display. A screen (110) is provided on an inner face of the first chassis (10). The screen (110) may be a liquid crystal display (LCD) or an organic electroluminescence (EL) display, or another type of display. A camera sensor (130) may be disposed in a peripheral area of the screen (110) on the inner face of the first chassis (10).

A cartesian coordinate system is illustrated in FIG. 1 by the x-, y-, and z-axes (150x, 150y, 150z). As depicted, the first chassis (10) is oriented substantially within the y-z plane (150y)-(150z) with its first side face (10a) pointing in the positive z-direction. Thus, the first chassis (10) extends in a direction away from the hinge (15), parallel to the direction indicated by the z-axis (150z). The second chassis (20) is oriented substantially within the x-y plane (150x)-(150y) with its first side face pointing in the positive y-direction. Thus, the second chassis (20) extends in another direction away from the hinge (15), parallel to the direction indicated by the x-axis (150x).

The information processing apparatus (1) includes a chassis support (100). The first chassis (10) is slidably mounted on the chassis support (100). The chassis support (100) is connected to the hinge (15) such that the chassis support (100) and first chassis (10) rotate about the hinge (15) under rigid body rotation, together, relative to the second chassis (20). The first chassis (10) is slidable along the chassis support (100) in a direction away from and back towards the hinge (15) and has an adjustable position with respect to the hinge (15). As illustrated, the first chassis (10) may be slid along the chassis support (100) in a direction substantially parallel to the z-axis (150z) to adjust the height of the first chassis (10) above the second chassis (20). However, a person of ordinary skill in the art will appreciate that under a different rotation angle (θ), the first chassis (10) slides in a direction other than the z-direction. Regardless of the rotation angle (θ), because the hinge (15) is fixed to the second chassis (20), the position of the first chassis (10) is defined in a direction relative to the hinge (15). That is, regardless of the rotation angle (θ), the first chassis (10) may be slid in a direction away from and back towards the hinge (15).

The first chassis (10) is electronically connected to the second chassis (20) by wiring that extends from the first chassis (10) to the second chassis (20) through an interior (not visible) of the chassis support (100). The wiring maintains connectivity and electrical communication between the first chassis (10) and second chassis (20) for each position of the first chassis (10).

In one or more embodiments, the chassis support includes a first slide rail (101a) and a second slide rail (101b), and the first chassis (10) is slidably mounted to the first slide rail (101a) and the second slide rail (101b). Although not visible in FIG. 1, the chassis support (100) may connect behind, or through, the first chassis (10), from the first slide rail (101a) to the second slide rail (101b). The chassis support (100), including the first slide rail (101a) and second slide rail (101b), are made from substantially the same material as the first chassis (10), for example, aluminum, a magnesium alloy, plastic (e.g., acrylonitrile butadiene styrene, or ABS plastic), post-consumer recycled plastic, or carbon fiber. The first slide rail (101a) and second slide rail (101b) are reinforced with an increased thickness relative to the first chassis (10) in order to support the weight of the first chassis (10) in various positions.

FIG. 1 illustrates the information processing apparatus (1) in which the first chassis (10) is oriented in a first position, in accordance with one or more embodiments. In the first position, the first chassis (10) is fully retracted along the chassis support (100) and is not substantially displaced from the hinge (15). For example, when the first chassis (10) is in the first position and the rotation angle (θ) is 0° (i.e., the information processing apparatus (1) is closed), the first side face (10a) of the first chassis (10) is substantially flush with the first side face (20a) of the second chassis (20).

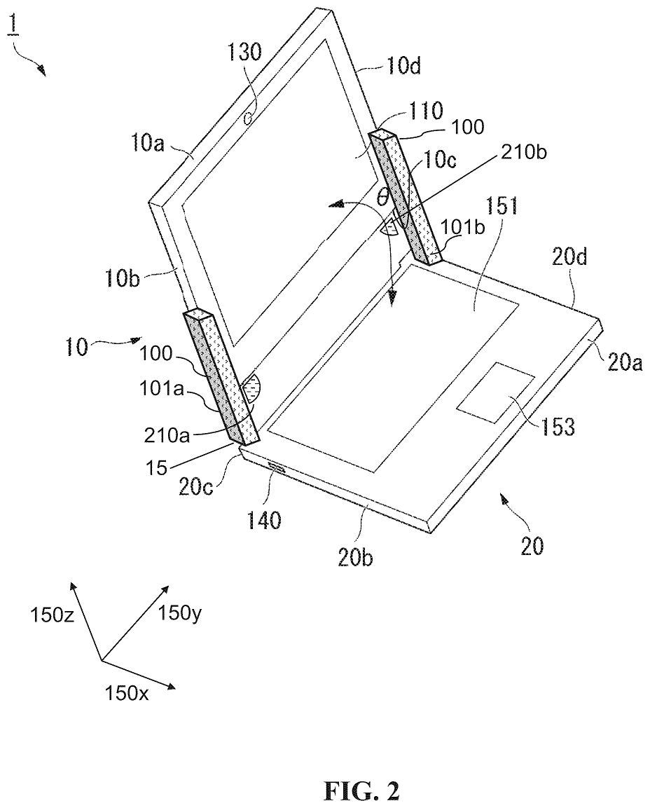

FIG. 2 illustrates the information processing apparatus (1) in which the first chassis (10) is oriented in a second position, in accordance with one or more embodiments. A locking system locks the first chassis (10) in the first position. To adjust the first chassis (10) from the first position to the second position, the locking system is released and the first chassis (10) is slid along the chassis support (100) in a direction away from the hinge (15). Upon reaching the second position, the locking system automatically locks the first chassis (10) in the second position. In the second position. the first chassis (10) is elevated relative to the second chassis (20). For example, the height of the first chassis (10) above the second chassis (20) is between about 4-6 cm when the first chassis (10) and the second chassis (20) are substantially perpendicular. As illustrated, the first chassis (10) is displaced along the z-axis (150z) in the second position.

The locking system is disposed within the chassis support (100) and mechanically secures the first chassis (10) to the chassis support (100). The locking system may be released through a button disposed along an edge of the chassis support (100) or on the first chassis (10) that is mechanically connected to one or more individual locks (210a, 210b). For example, in one or more embodiments, the locking system (210a, 210b) includes two individual locks, a first lock (210a) and a second lock (210b). The first lock (210a) is disposed on an inner edge of the first slide rail (101a) and the second lock is disposed on an inner edge of the second slide rail (101b). The first lock (210a) and second lock (210b) may be connected to one another such that engaging or releasing the first lock (210a) engages or releases the second lock (210b). Accordingly, although two locks (210a, 210b) are used in such embodiments, together they form a single locking mechanism. The position of the first lock (210a) and the second lock (210b) along the first slide rail (101a) and second slide rail (101b), respectively, provide structural integrity and stability to the information processing apparatus (1). In one or more embodiments, the locking system of the chassis support (100) includes only a single lock (e.g., either first lock (210a) or second lock (210b)).

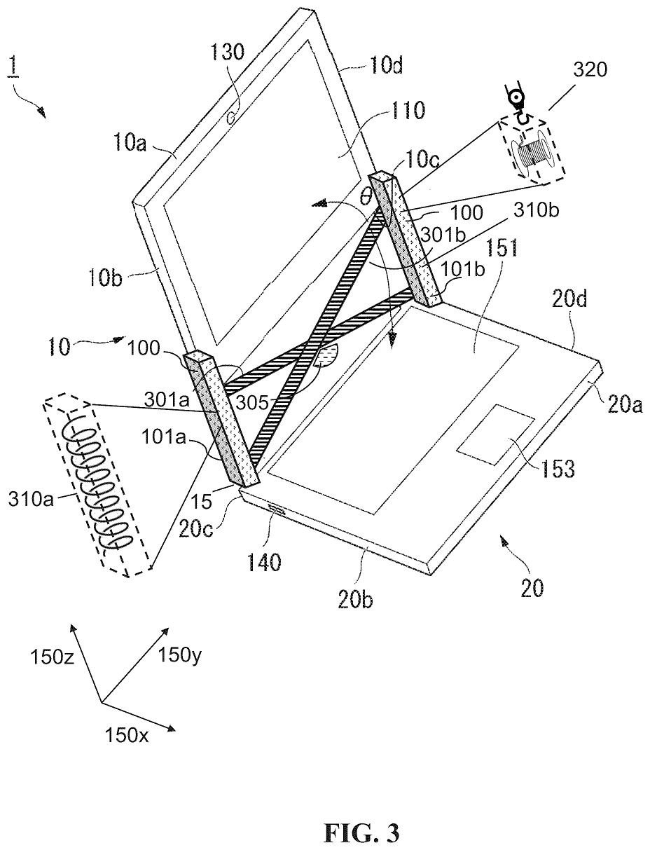

FIG. 3 illustrates the information processing apparatus (1) in which the first chassis (10) is oriented in a third position, in accordance with one or more embodiments. The first chassis (10) may be adjusted to the third position from either the first position or the second position. To adjust the first chassis (10) from either the first position or the second position to the third position, the locking system (210a, 210b) is released and the first chassis (10) is slid along the chassis support (100) in a direction away from the hinge (15). Upon reaching the third position, the locking system (210a, 210b) automatically locks the first chassis (10) in the third position. In the third position, the first chassis (10) is further from the hinge (15) than in the second position, and the first chassis (10) is thus elevated relative to the second chassis (20) by even greater amount. For example, the height of the first chassis (10) above the second chassis (20) is between about 9-11 cm when the first chassis (10) and the second chassis (20) are substantially perpendicular. As illustrated, the first chassis (10) is displaced along the z-axis (150z) in the third position.

In accordance with one or more embodiments, the chassis support (100) includes a first support bar (301a) and a second support bar (301b). The first support bar (301a) and second support bar (301b) are stored behind the first chassis (10) or within the first chassis (10) as part of the chassis support (100). The first support bar (301a) and second support bar (301b) extend from the chassis support (100) in a space formed between the hinge (15) and the first chassis (10) and connect from either corner of the third side face (10c) of the first chassis (10) to the opposite corner of the chassis support (100), adjacent to the third side face (20c) of the second chassis (20) and the hinge (15). That is, the first support bar (301a) and second support bar (301b) extend and overlap to form an “X” shape in the space formed between the hinge (15) and the first chassis (10). Alternatively, the first support bar (301a) and second support bar (301b) may connect from either corner of the third side face (10c) of the first chassis (10) and a center position of the hinge (15), thereby forming a “V” shape. The first support bar (301a) and the second support bar (301b) distribute the load of the first chassis (10) about the chassis support (100), providing greater structural integrity and stability to the information processing apparatus (1).

The support bars (301a, 301b) extend automatically from the chassis support (100) in response to releasing the locking system (210a, 210b) and sliding the first chassis to the third position. The locking system of the chassis support (100) includes a third lock (305) disposed beneath a point of overlap between the first support bar (301a) and the second support bar (301b). The third lock (305) mechanically secures the support bars (301a, 301b) in the extended supporting position described above (e.g., in the “X” shape or in the “V” shape).

The third lock (305) is only engaged in conjunction with the support bars (301a, 301b). That is, the third lock (305) does not secure the first chassis (10) in the first position and is not automatically used in the second position. However, if the first chassis (10) is arranged the second position, the user may manually extend the support bars (301a, 301b) to provide additional stability to the first chassis (10) while the first chassis (10) is in the second position. Subsequently, after manually extending the support bars (301a, 301b), the third lock mechanically secures the support bars (301a, 301b) as it does in the third position. The third lock (305) may be mechanically coupled to the first and second locks (210a, 210b) such that releasing the third lock (305) automatically releases the first and second locks (210a, 210b). The third lock may also be released individually.

In one or more embodiments, the chassis support (100) includes locking mechanisms (not shown) in the corners of the chassis support (100) that the first and second support bars (301a, 301b) extend and connect into (i.e., the corners opposite the corners of the third side face (10c)). The corner locking mechanisms mechanically secure the end points of the first and second support bars (301a, 301b) to the respective corners of the chassis support (100). The first lock (210a), second lock (210b), third lock (305), and corner locking mechanisms may include mechanical locking mechanisms, magnetic locking mechanisms, or both.

The chassis support (100) includes a spring system that includes a first spring (310a) and a second spring (310b). The first spring (310a) and second spring (310b) are disposed within the chassis support (100), for example, along or within the first slide rail (101a) and the second slide rail (101b), respectively. The dashed lines shown in FIG. 3 emphasize that the springs (310a, 310b) are internal to the first and second slide rails (101a, 101b) and are not visible from the outside. When the first chassis (10) is in the first position, the springs (310a, 310b) are compressed. After releasing the locking system (e.g., first lock (210a) and second lock (210b)), the potential energy stored by the spring system (e.g., first spring (310a) and second spring (310b)) is released to assist the user in adjusting the first chassis (10) into either the second position or the third position. Similarly, the spring system assists the user in adjusting the first chassis (10) from the second position to the third position.

The chassis support (100) may include an internal micropulley system (320) configured to smoothly deliver and retract the electrical wiring connecting the first chassis (10) and the second chassis (20) in response to sliding the first chassis (10) from one position to another. As described above, the electrical wiring is disposed within the chassis support (100), for example, within the first slide rail (101a) or within the second slide rail (101b). Generally, the wiring has a length that provides slack to the wiring when the first chassis (10) is in the first position. In addition, a space is provided between the first chassis (10) and the chassis support (100) so that the wiring is not impacted by changing the position of the first chassis (10). However, to further prevent damage to the electrical wiring, the micropulley system (320) includes a spool that the electrical wiring is wound upon. A micropulley is fixed on one end to the first slide rail (101a) or the second slide rail (101b) and on the other hand to the spool, keeping the wiring in place on each end. In response to sliding the first chassis (10), the micropulley system (320) automatically adjusts the wiring, providing greater length of wiring when the first chassis is slid away from the hinge (15) and shortening the length of wiring when the first chassis is slid towards the hinge (15). To this end, the spool of the micropulley system (320) may include a flat spiral spring, or steel belt, similar to those used in tape measures, to automatically retract the wiring when the locking system is released and the first chassis (10) is slid from one position to another. Again, the dashed lines shown in

FIG. 3 emphasize that the micropulley system (320) is internal to the first or second slide rail (101a, 101b) and is not visible from the outside.

As described above, the chassis support (100) provides at least three stable and secure positions for the first chassis (10), namely, the first position in which the first chassis (10) is nearest to the hinge (15); the second position in which the first chassis (10) is at a distance from the hinge (15); and a third position in which the first chassis (10) is at a greater than the first distance from the hinge (15) than in the second position. In one or more embodiments, the chassis support (100) enables the user to select any user-defined position for the first chassis (10) between a minimum and maximum distance of displacement from the hinge (15). In such embodiments, the locking system may include friction elements (e.g., clamp-style collars, one within each of the first slide rail (101a) and second slide rail (101b)) that are engaged and released by the user and that secure the first chassis (10) at any given position.

Alternatively, or in addition, the first slide rail (101a) and second slide rail (101b) may include grooves (not shown) that interlock with grooves arranged on an inner surface of the first chassis (10). The user may adjust the height of the first chassis (10) by first applying a first force substantially perpendicular to and away from the chassis support (100) (e.g., in the x-direction (150x)) and then applying a second force substantially parallel to the chassis support (100) and away from the hinge (15) (e.g., in the z-direction (150z)) to slide the first chassis (10) into a new position. The first force thereby separates the interlocking grooves, and the second force slides the first chassis (10) into the new position. Once the first chassis (10) is in the new position, a third force may be applied to interlock the grooves of the first slide rail (101a) and the second slide rail (101b) with the grooves of the inner surface of the first chassis (10). To lower the first chassis (10), the same steps are performed but with the second force is applied in the opposite direction (i.e., towards the hinge (15)). The support bars (301a, 301b) may be manually extended by the user in any of the user-defined positions of the first chassis (10).

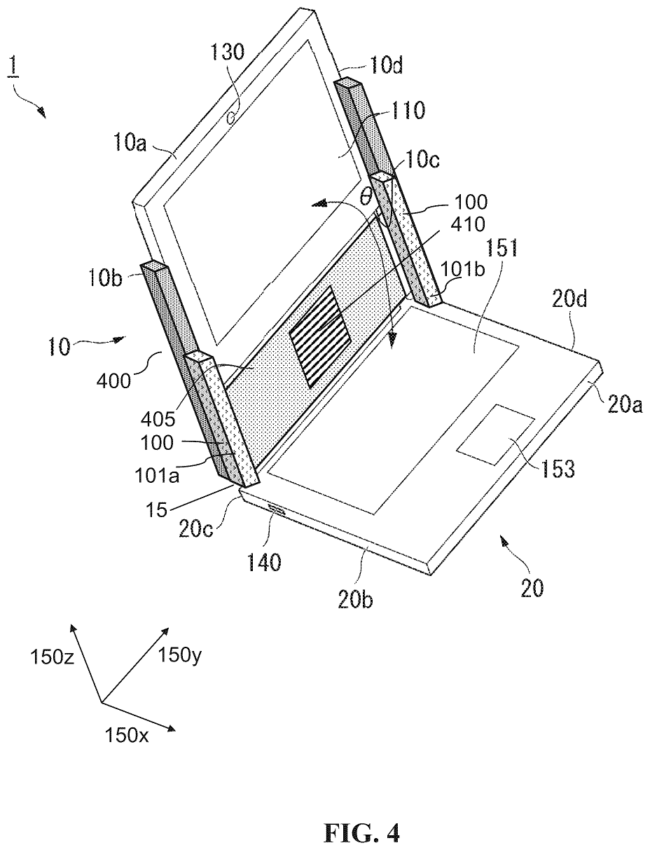

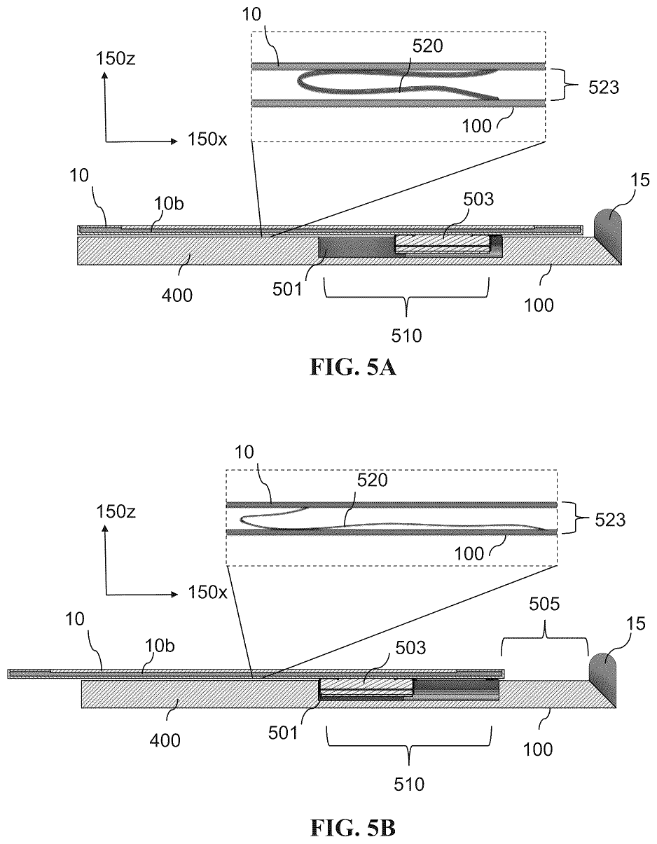

FIG. 4 depicts the information processing apparatus (1) in which the first chassis (10) is oriented in either the second position or the third position, in accordance with one or more embodiments. As depicted, the chassis support (100) includes a protective shell (400) that covers the back portion of the first chassis (10). In one or more embodiments, the protective shell (400) encases the first chassis (10) on either side. However, in other embodiments (such as the embodiments depicted in FIGS. 5A and 5B below), the protective shell only covers the back portion of the first chassis (10). The protective shell (400) is made of substantially the same material as the first chassis (10) and the chassis support (100). The protective shell (400) provides additional support to the first chassis (10) in a position of elevation (e.g., the second or third position). The first chassis (10) slides parallel to an inner surface (405) of the protective shell (400), assisted by the spring system described above and locked into place using the locking system described above. Although illustrated separately from the protective shell (400) in FIG. 4, the first slide rail (101a) and second slide rail (101b) may be part of the protective shell (400) or may be housed within the protective shell (400) such that they are not externally visible.

In place of the support bars (301a, 301b), an inner surface (405) of the protective shell (400) covers the space formed between the hinge (15) and the first chassis (10) when the first chassis (10) is in either the second position or the third position. The inner surface (405) is exposed when the first chassis (10) is in either the second position or the third position and provides space for additional components and may include, for example, an inductive charging plate (410). The inductive charging plate (410) is powered by the information processing apparatus (1) and can be used to charge an external user device (e.g., a cellphone or case for headphones). To provide enough space for certain devices to fit properly upon the inductive charging plate (410), the first chassis (10) may need to be displaced by at least 70 mm.

FIGS. 5A and 5B depict the first chassis (10) and chassis support (100) in accordance with one or more embodiments. For clarity, the second chassis (20) is not shown. In FIGS. 5A and 5B, the frame of reference is rotated with respect to the frame of reference of FIGS. 1-4, as indicated by the directions of the x-axis (150x) and the z-axis (150z). That is, FIGS. 5A and 5B depict the first chassis (10) and chassis support (100) as viewed perpendicular, or edge on, with respect to the second side face (10b). As in FIG. 4, the embodiments depicted by FIGS. 5A and 5B include a protective shell (400).

FIG. 5A depicts the first chassis (10) in the first position, where the first chassis (10) is not substantially displaced from the hinge (15). FIG. 5B depicts the first chassis (10) in the third position, where the first chassis (10) is displaced a maximum allowable distance from the hinge (15). According to the embodiments depicted in FIGS. 5A and 5B, the maximum displacement distance is set by the size (510) internal slot (501), or cavity, that encloses a mechanical sliding connector (503). The mechanical sliding connector (503) attaches the first chassis (10) to the protective shell (400). The mechanical sliding connector (503) is fixed in place on the first chassis (10) and slidably mounted to the first slide rail (101a) and second slide rail (101b). A bottom edge of the internal slot (501) begins at a distance from the hinge (15) that is substantially equal to the maximum distance (505) so that it is not visible when the first chassis (10) is maximally displaced. In one or more embodiments, the length of the protective shell (400) is at least three times the maximum distance (505).

In FIG. 5A, an inset panel shows the electrical wiring (520) connecting the first chassis (10) to the chassis support (100) in accordance with one or more embodiments. As described above, the electrical wiring (520) has a length that provides slack to the wiring (520) when the first chassis (10) is in the first position. In addition, a space (523) is provided between the first chassis (10) and the chassis support (100) so that the wiring is not impacted by changing the position of the first chassis (10).

In FIG. 5B, the first chassis (10) slides a maximum distance (505) away from the hinge (15). An inset panel shows the electrical wiring (520) again, where the wiring (520) is stretched but still not fully extended, thereby preventing damage to the wiring (520) when displacing the first chassis (10).

The first chassis (10) of the information processing apparatus (1) may be adjusted from the third position into the second position, or from either the third position or second position into the first position, by releasing the locking system (e.g., first lock (210a), second lock (210b), and third lock (305)) and gently sliding the first chassis toward the hinge (15).

Embodiments of the disclosure have one or more of the following advantages. Conventional information processing apparatuses are not necessarily designed to promote a healthy or even a comfortable posture for the user. However, embodiments of the present disclosure include an information processing apparatus (1) with a screen disposed within a first chassis (10) that has an adjustable height. The adjustable height of the first chassis (10) accommodates a variety of sitting and standing positions as well as different heights of users. Accordingly, embodiments of the present disclosure reduce the need for external equipment (e.g., external displays, keyboards, etc.) that a user might otherwise need in order to achieve a healthy or comfortable posture, thereby reducing costs and materials waste.

In addition, the information processing apparatus (1) according to embodiments of the present disclosure reduces discomfort and fatigue during prolonged periods of use by allowing for and promoting proper posture. Reducing discomfort and fatigue can increase productivity and allow for greater focus as well as longer work periods. A workstation with proper ergonomic accommodation can also prevent a range of health problems, from back and neck pain to more serious conditions such as carpal tunnel syndrome. Further, ergonomic improvements have been shown to reduce absenteeism in places of employment, as fewer employees need to take time off work due to occupational health issues. Improved ergonomics may also contribute to the psychological well-being of users by promoting satisfaction and comfort.

Although only a few example embodiments have been described in detail above, those skilled in the art will readily appreciate that many modifications are possible in the example embodiments, and that the embodiments described above may be combined or modified without materially departing from this invention. Accordingly, all such modifications are intended to be included within the scope of this disclosure as defined in the following claims.

What is claimed is:

1. An information processing apparatus, comprising:
a chassis support;
a first chassis slidably mounted on the chassis support;
a second chassis rotatably connected to the chassis support by a hinge;
wherein the first chassis is electronically connected to the second chassis by wiring that extends from the first chassis to the second chassis through an interior of the chassis support; and
a locking system that locks the first chassis in a first position, and in response to releasing the locking system and sliding the first chassis to a second position in a direction away from the hinge, locks the first chassis in the second position.

2. The information processing apparatus of claim 1, wherein the chassis support comprises a first slide rail and a second slide rail; and
wherein the first chassis is slidably mounted to the first slide rail and the second slide rail.

3. The information processing apparatus of claim 2:
wherein the chassis support further comprises a first support bar and a second support bar;
wherein the first support bar and the second support bar automatically extend from the chassis support, in a space formed between the hinge and the first chassis, in response to releasing the lock and sliding the first chassis to a third position in the direction away from the hinge; and
wherein the third position is further from the hinge than the second position.

4. The information processing apparatus of claim 3:
wherein the locking system comprises a first lock disposed on an inner edge of the first slide rail and a second lock disposed on an inner edge of the second slide rail; and
wherein the first lock and the second lock, together, lock the first chassis in a first position, and in response to releasing the first lock and second lock and sliding the first chassis to the second position or the third position, lock the first chassis in the second position or the third position.

5. The information processing apparatus of claim 4, wherein the first support bar and the second support extend and overlap to form an “X” shape in the space formed between the hinge and the first chassis in the third position in response to releasing the locking system and sliding the first chassis to the third position.

6. The information processing apparatus of claim 5:
wherein the locking system further comprising a third lock;
wherein the third lock is disposed beneath a point of overlap between the first support bar and the second support bar; and
wherein the first lock, the second lock, and the third lock, together, lock the first chassis in a first position lock the first chassis in the third position in response to releasing the first lock and second lock and sliding the first chassis to the third position.

7. The information processing apparatus of claim 2 further comprising:
a first spring disposed on the first slide rail; and
a second spring disposed on the second slide rail;
wherein the first spring and the second spring are compressed in response to the first chassis being in the first position.

8. The information processing apparatus of claim 1, further comprising a micropulley system that automatically adjusts the wiring in response to sliding the first chassis.

9. The information processing apparatus of claim 1:
wherein the chassis support comprises a protective shell; and
wherein the first chassis slides parallel to an inner surface of the protective shell.

10. The information processing apparatus of claim 9, wherein the protective shell covers a space formed between the hinge and the first chassis in the second position in response to sliding the first chassis to the second position or to a third position in the direction away from the hinge;
wherein the third position is further from the hinge than the second position.

11. The information processing apparatus of claim 10, wherein the protective shell comprises an inductive charging plate on the inner surface of the protective shell that is exposed in the space formed between the hinge and the first chassis in response to sliding the first chassis to the second position or the third position.
